(19) United States
(12) Patent Application Publication
(10) Pub. No.: US 2026/0103947 A1
(43) Pub. Date: Apr. 16, 2026

(54) LADDER ATTACHMENT APPARATUS

(71) Applicant: William David Harley, Worland, WY (US)

(72) Inventor: William David Harley, Worland, WY (US)

(21) Appl. No.: 18/917,359

(22) Filed: Oct. 16, 2024

(51) Int. Cl. E06C 1/32; E06C 7/48

(52) U.S. Cl. CPC E06C 1/32; E06C 7/48

(57) ABSTRACT

A ladder attachment apparatus with two attachment assemblies and a stabilizing bar. Each attachment assembly has two pivoting members that are mirror images of each other. Each pivoting member has top and bottom portions, and the top portion has an aperture that is configured to receive the stabilizing bar. The top portion of each pivoting member has first and second plates that are arranged parallel to each other. In the inner pivoting member, the first and second plates are situated on top of the top plate of the bottom portion. In the outer pivoting member, the first and second plates are situated on either side of the top plate of the bottom portion. The bottom portion is in the form of a rectangular box with an open bottom end. One side wall of the bottom portion has a cutout that is configured to receive a run of a ladder.

### BACKGROUND OF THE INVENTION

### 1. Field of the Invention

The present invention relates generally to the field of rescue equipment, and more particularly, to an apparatus for attaching the top ends of two extension ladders together to form an A-frame.

### 2. Description of the Related Art

A-frame lifting platforms are used by fire departments, corporations and workers for lifting purposes not just in rescue operations but also in any conceivable situation requiring overhead lifting. This includes lifting people or things out of manholes, well shafts, grain bins or silos, etc. In a typical rescue situation, an A-frame lifting platform is created by manually lashing two extension ladders together. A lifting system is attached to the top of the A-frame with webbing straps, and the A-frame is positioned across the opening above the patient. The patient is loaded into a rescue litter basket, which is then lifted out through the access hole by firefighters using the lifting system.

The process of lashing two ladders together is time-consuming, and the lashed ladders are not particularly stable. This is because as the two ladders are lashed together, the ladder beams become offset to each other, causing the system not to be square. The present invention solves these problems by providing an apparatus that is configured to slide over the tops of the beams of two ladders, thereby securing the ladders together in an A-frame configuration and providing an extremely stable platform for the lifting procedure. The present invention is designed to accommodate different sizes of ladders, provided that the two ladders are of the same width. There is nothing in the prior art that resembles the present invention in terms of structure or purpose.

U.S. Pat. No. 4,060,150 (Hughes, 1977) provides a kit for constructing a ladder so that it can be assembled in a number of ways, resulting in various types of ladder structures. The kit includes a plurality of elongated tubular elements and a frame member with a pair of rung holder brackets. The rung holder brackets have a surface edge that abuts the side rail. Fastening elements pass through the brackets and into the side rails. The rungs are fixed in the brackets and received by apertures in the side rails. In one embodiment, the ladder assembly is used as a scaffold. In this configuration, a plurality of side rails and frame members are joined to form two ladder sections, which are then connected by means of angular members and straight members to space the tops of the ladder sections apart from each another. A section of planking provides a scaffold structure, and an optional tension member (such as a chain or cable) is used to stabilize the system. In another embodiment, two bridge pieces connect the two sides of the ladder assembly together, and a platform acts as a supporting surface. A telescoping foot section is coupled to the lower side rails to create a widened base for added stability.

U.S. Patent Application Pub. No. 2013/0161127 (Allred, III et al.) discloses a dual-use ladder and bridge modular system in which a removable platform is used to convert a segmented ladder system into a bus assault ladder/platform. In this invention, a pair of carbon fiber tubes form a pair of tubular carbon fiber side rails, and a carbon fiber rung connects the two side rails together. The invention further comprises a deck and two removable deck connectors that are configured to join the side rails to the deck.

### BRIEF SUMMARY OF THE INVENTION

The present invention is a ladder attachment apparatus comprising: a first attachment assembly; a second attachment assembly; and a stabilizing bar; wherein each of the first and second attachment assemblies comprises a first pivoting member and a second pivoting member; wherein each pivoting member is comprised of a top portion and a bottom portion; wherein the top portion is comprised of a first plate and a second plate; wherein the first plate and the second plate are arranged so that they are parallel to each other, wherein each of the first plate and the second plate comprises an aperture that is configured to receive the stabilizing bar; wherein the bottom portion of each pivoting member is in the form of a rectangular box with an open bottom end; and wherein the bottom portion of each pivoting member comprises a first side wall with a cutout that is configured to receive a rung of a ladder when the rung is perpendicular to the side wall.

In a preferred embodiment, each of the first plate and the second plate has a rounded extension that is angled inwardly toward the stabilizing bar and a top edge that angles downwardly from the rounded extension to an outer edge of the top portion. Preferably, the bottom portion of each of the pivoting members comprises an elongated bracket that is configured to form a channel for receiving a part of a ladder, and the elongated bracket is situated on a second side wall of the bottom portion. The stabilizing bar has a first end and a second end and preferably comprises a first lynch pin on the first end of the stabilizing bar and a second lynch pin on the second end of the stabilizing bar.

In a preferred embodiment, the present invention further comprises a pair of safety brackets on each pivoting member, with a first safety bracket being situated on a first side of a bottom end of the cutout on the first side wall and a second safety bracket being situated on a second side of the bottom end of the cutout on the first side wall, and both of the first and second safety brackets are configured to receive a safety pin. Preferably, the bottom member comprises a top plate, and the first plate and the second plate of the top portion of the first pivoting member are situated on top of the top plate of the bottom member. Preferably, the first plate and the second plate of the top portion of the second pivoting member are situated on either side of the top plate of the bottom member.

### BRIEF DESCRIPTION OF THE DRAWINGS

FIG. 1 is a perspective view of the first attachment assembly of the present invention.

FIG. 2 is a first top view of the inner pivoting member of the first attachment assembly.

FIG. 3 is a second top view of the inner pivoting member of the first attachment assembly.

FIG. 4 is a first side view of the inner pivoting member of the first attachment assembly.

FIG. 5 is a front view of the inner pivoting member of the first attachment assembly.

FIG. 6 is a second side view of the inner pivoting member of the first attachment assembly.

FIG. 7 is a first bottom view of the inner pivoting member of the first attachment assembly.

FIG. 8 is a second bottom view of the inner pivoting member of the first attachment assembly.

FIG. 9 is a first top view of the outer pivoting member of the first attachment assembly.

FIG. 10 is a second top view of the outer pivoting member of the first attachment assembly.

FIG. 11 is a first side view of the outer pivoting member of the first attachment assembly.

FIG. 12 is a front view of the outer pivoting member of the first attachment assembly.

FIG. 13 is a second side view of the outer pivoting member of the first attachment assembly.

FIG. 14 is a first bottom view of the outer pivoting member of the first attachment assembly.

FIG. 15 is a second bottom view of the outer pivoting member of the first attachment assembly.

FIG. 16 is a side view of the attachment assembly of the present invention shown in a first position with the top part of a ladder inserted into the bottom portion of each of the two pivoting members.

FIG. 17 is a side view of the attachment assembly of the present invention shown in a second position with the top part of a ladder inserted into the bottom portion of each of the two pivoting members.

FIG. 18 is the same as FIG. 17 with an extended view of the ladders.

FIG. 19 is a side view of the attachment assembly of the present invention shown in a third position with the top part of a ladder inserted into the bottom portion of each of the two pivoting members.

FIG. 20 is a section view of both attachment assemblies on the stabilizing bar shown with the two pivoting members of each attachment assembly in a first orientation relative to each other.

FIG. 21 is a section view of both attachment assemblies on the stabilizing bar shown with the two pivoting members of each attachment assembly in a second orientation relative to each other on the left-hand side of this figure and in a third orientation relative to each other on the right-hand side of this figure.

FIG. 22 is a rear view of the present invention shown with the two attachment assemblies in different configurations.

FIG. 23 is a perspective view of the inner pivoting member shown with the elongated bracket in an exploded position.

FIG. 24 is a perspective view of the inner pivoting member shown with the elongated bracket in an installed position.

FIG. 25A is a perspective view of the outer pivoting member shown in relation to the top part of a ladder with the safety pin removed.

FIG. 25B is a perspective view of the inner pivoting member shown with the top part of a ladder inserted into the bottom portion of the pivoting member.

FIG. 26 is a perspective view of the present invention shown with one of the lynch pins detached from one end of the stabilizing bar.

### REFERENCE NUMBERS

1 Attachment assembly
2 Stabilizing bar
3 Pivoting member
3a Top portion (of pivoting member)
3b Bottom portion (of pivoting member)
3c Plate (of top portion)
3d Rounded extension (of plate)
3e Central aperture (of rounded extension)
3f Top edge (of top portion)
3g First side wall (of bottom portion)
3h Second side wall (of bottom portion)
3i First end wall (of bottom portion)
3j Second end wall (of bottom portion)
3k Top plate (of bottom portion)
3l Arch-shaped cutout (in second side wall)
3m Elongated bracket
4 Safety bracket
5 Safety pin
6 Ladder
6a Rung (of ladder)
7 Lynch pin

### DETAILED DESCRIPTION OF INVENTION

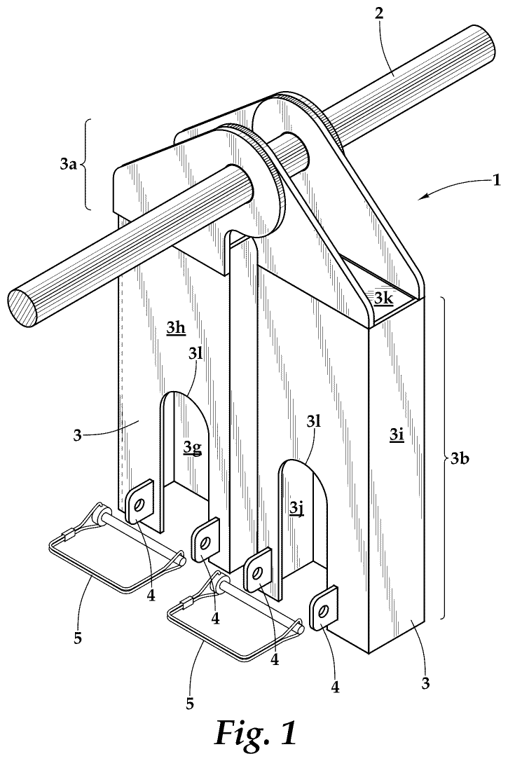

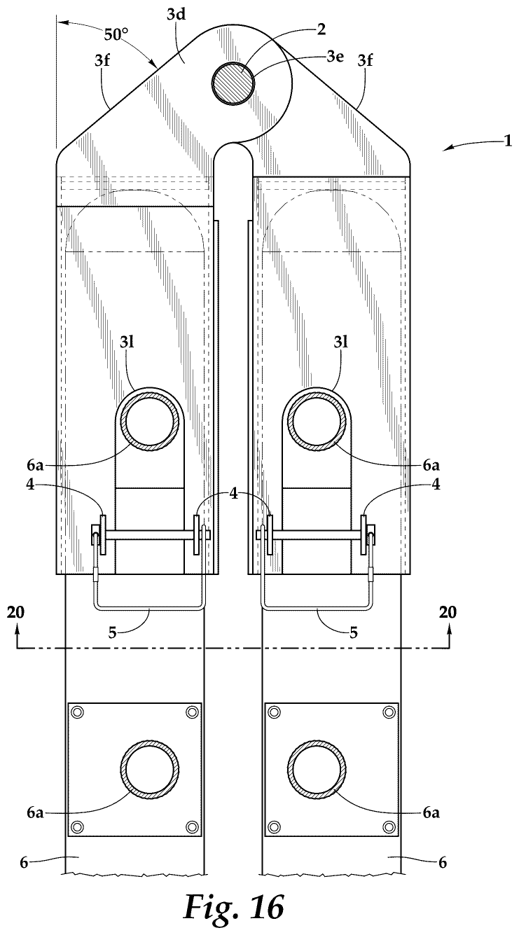

FIG. 1 is a perspective view of the first attachment assembly of the present invention. The present invention is comprised of two attachment assemblies 1, one of which is shown here, and a stabilizing bar 2. The two attachment assemblies are identical mirror images of each other. Each attachment assembly is comprised of a pair of pivoting members 3. Each pivoting member 3 is comprised of a top portion 3a and a bottom portion 3b. The top portion 3a is comprised of two parallel plates 3c, each of which has a rounded extension 3d that is angled inwardly (that is, toward the stabilizing, bar 2) and that has a central aperture 3e through which the stabilizing bar 2 passes. Each top portion 3a further comprises a top edge 3f that angles downwardly from the rounded extension 3d to the outer edge of the top portion 3a. In a preferred embodiment, this angle is approximately forty-five degrees (45°). See also FIG. 16.

The bottom portion 3b of each pivoting member 3 is in the form of a rectangular box with a first side wall 3g, second side wall 3h, first end wall 3i and second end wall 3j. The bottom of each bottom portion 3b is open and configured to receive a top end of an extension ladder. The top of each bottom portion 3b is closed with a top plate 3k. The first and second side walls 3g, 3h are the same size, except that the second side wall 3h comprises an arch-shaped cutout 31 on the bottom half of the second side wall 3h. Parallel safety brackets 4 on either side of the bottom end of the arch-shaped cutout 31 are configured to receive a safety pin 5. The purpose of the safety pin 5 is to secure the top ends of the extension ladder in the bottom portion 3b of the attachment assembly 3; because there is a ladder run above the safety pin 5, the safety pin prevents the ladder from slipping downward (see FIG. 25). The first and second end walls 3i, 3j are the same size. The two side walls 3g, 3h and the two end walls 31, 3j form the rectangular box shape of the bottom portion 3b of the attachment assembly 3.

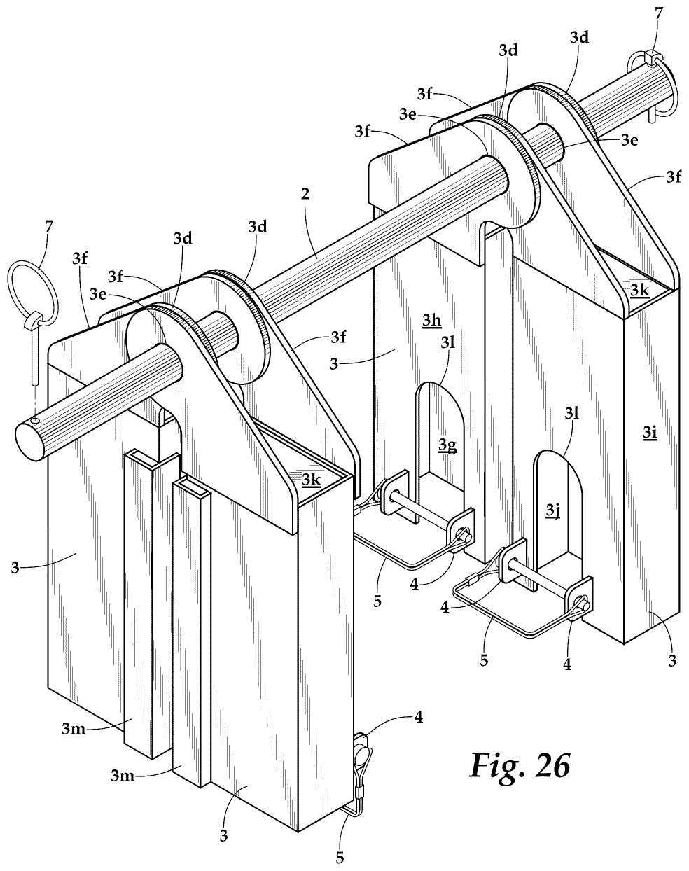

As shown in FIG. 26, the present invention is comprised of two attachment assemblies 1 that are mirror images of each other. Each attachment assembly 1 is comprised of an inner pivoting member 3 and an outer pivoting member 3. In FIG. 1, the inner pivoting member is situated to the right of the outer pivoting member, which is shown on the left. The two pivoting members together comprise a single attachment assembly. There is only one difference between the inner and outer pivoting members, and this difference is discussed below in connection with FIGS. 5 and 12.

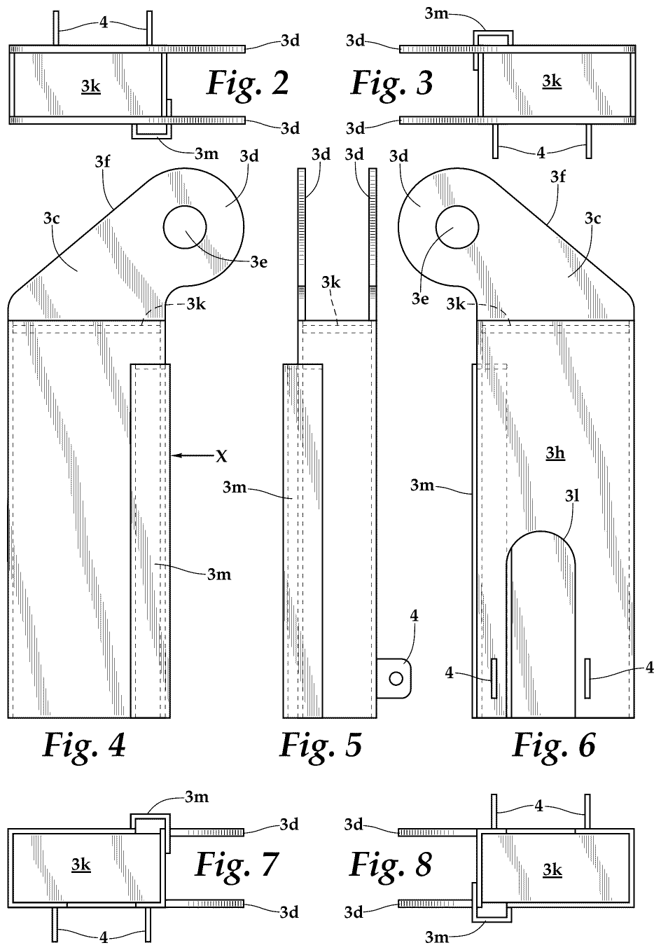

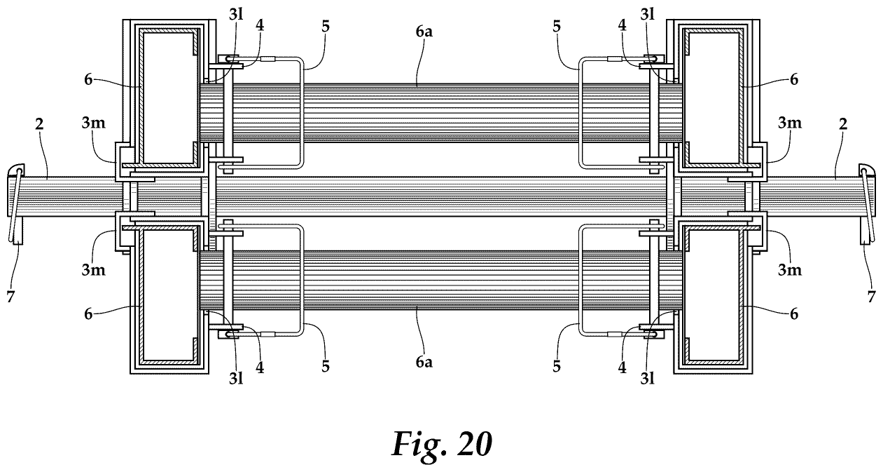

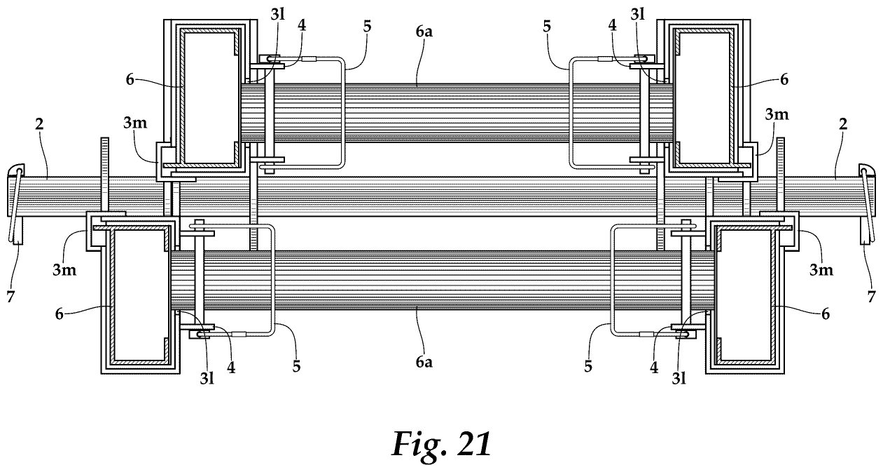

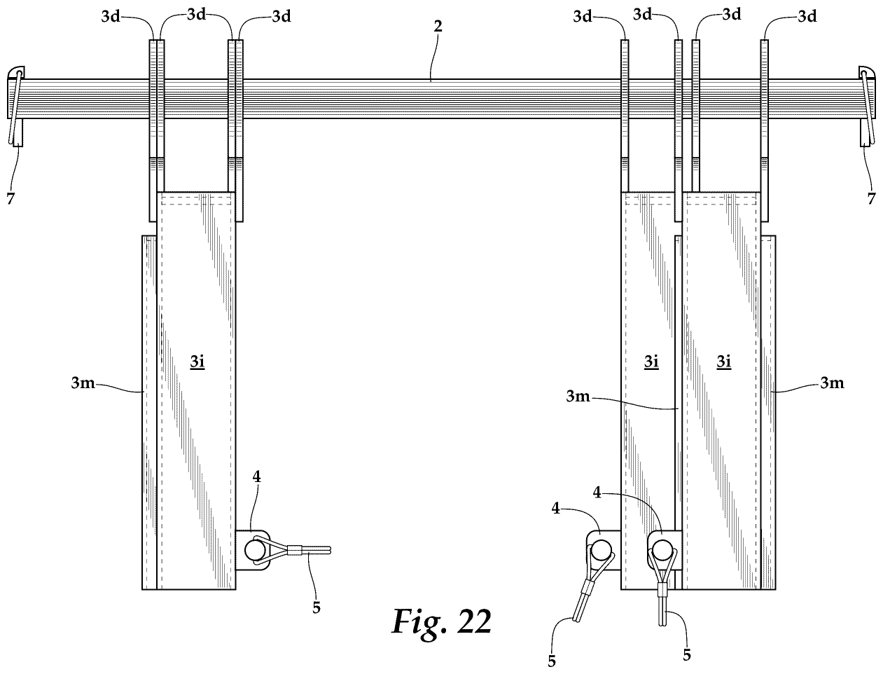

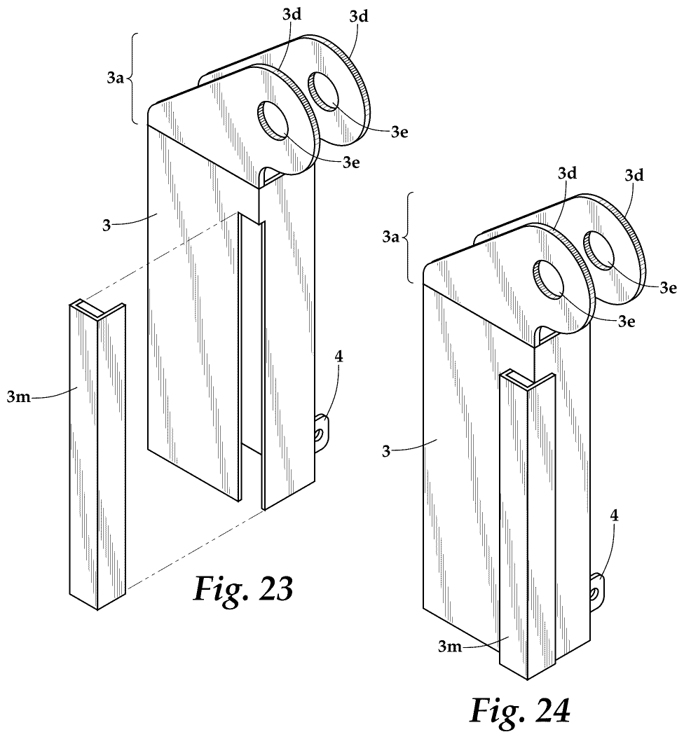

FIG. 2 is a first top view of the inner pivoting member of the first attachment assembly, and FIG. 3 is a second top view of the inner pivoting member of the attachment assembly, As shown in these two figures, the pivoting member 3 preferably comprises an elongated bracket 3m that is built into the bottom portion 3b of the pivoting member to form a channel. This channel is situated along the outer front edge of the pivoting member 3, as shown in FIGS. 22 and 23, and runs from the bottom (open) end of the bottom portion 3b to a top part of the bottom portion just underneath the plate 3c. The purpose of this channel is to accommodate a part of the extension ladder when it is inserted into the bottom end of the bottom portion 3b (see also FIGS. 20 and 21). For references purposes, as used herein, the term “front” refers to that part of the pivoting member 3b that is marked with an “X”on FIG. 4.

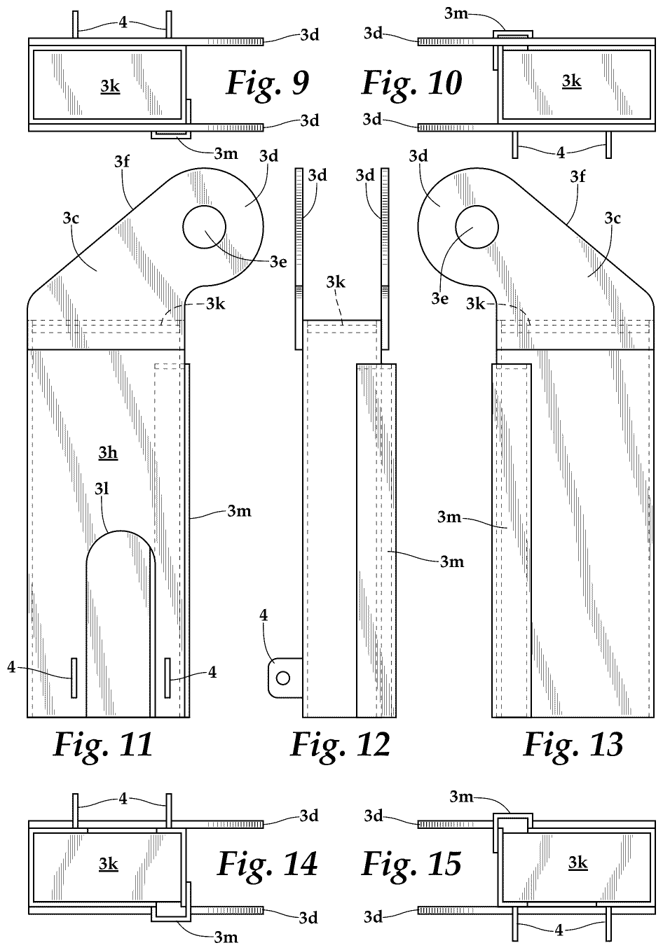

FIG. 4 is a first side view of the inner pivoting member of the first attachment assembly, FIG. 5 is a front view of the inner pivoting member of the first attachment assembly, and FIG. 6 is a second side view of the inner pivoting member of the first attachment assembly. The inner pivoting member of the second attachment assembly is a mirror image of the inner pivoting member of the first attachment assembly. As shown in FIG. 5, the two plates 3a on top of the top plate 3k are situated so that the outer surface of each plate 3a does not extend beyond the first and second side walls 3g, 3h. This is in contrast to the outer pivoting member, which is shown in FIGS. 9-15. Note that the elongated bracket 3m is situated on the first side wall 3g, whereas the arch-shaped cutout 31 is situated on the second side wall 3h. (In the claims, the side wall with the arch-shaped cutout is referred to as the “first” side wall, and the side wall with the elongated bracket is referred to as the “second” side wall. This is merely because of the order in which these terms are introduced in the claims.)

FIG. 7 is a first bottom view of the inner pivoting member of the first attachment assembly, and FIG. 8 is a second bottom view of the inner pivoting member of the first attachment assembly. The top view shown in FIG. 2 and the bottom view shown in FIG. 7 both correspond to FIG. 4. The top view shown in FIG. 3 and the bottom view shown in FIG. 8 both correspond to FIG. 6. All of the figures shown on this sheet relate to the inner pivoting member of the first attachment assembly. These same views would apply equally to the inner pivoting member of the second attachment assembly, except that they would be mirror images of those shown here.

FIG. 9 is a first top view of the outer pivoting member of the first attachment assembly, and FIG. 10 is a second top view of the outer pivoting member of the first attachment assembly. If these two figures are compared to FIGS. 2 and 3, it is apparent that the plates 3c are further apart in FIGS. 9 and 10 than they are in FIGS. 2 and 3. This is because on the outer pivoting member, the plates 3e are situated on either side of the top plate 3k rather than on top of it. This is the only difference between the inner and outer pivoting members. This difference exists so that the plates 3c on the inner pivoting member can fit inside of the plates 3c on the outer pivoting member when the attachment assembly 1 is installed on the stabilizing bar 2, as shown in FIG. 1.

FIG. 11 is a first side view of the outer pivoting member of the first attachment assembly, FIG. 12 is a front view of the outer pivoting member of the first attachment assembly, and FIG. 13 is a second side view of the outer pivoting member of the first attachment assembly. These figures also illustrate the fact that the plates 3c are situated on either side of the top part of the bottom portion 3b of the pivoting member 3 rather than on top of the top plate 3k of the bottom portion 3b (compare FIG. 12 to FIG. 5). As will be obvious if FIGS. 2-8 are compared to FIGS. 9-15, and also by viewing FIG. 1, within a single attachment assembly, with the exception of the difference in placement of the plates 3c relative to the top plate 3k, the inner and outer pivoting members are mirror images of each other. Similarly, the entire second attachment assembly is a mirror image of the first attachment assembly (see FIG. 26).

FIG. 14 is a first bottom view of the outer pivoting member of the first attachment assembly, and FIG. 15 is a second bottom view of the outer pivoting member of the first attachment assembly, These figures also illustrate the different placement of the plates 3c relative to the top plate 3k, as noted above.

FIG. 16 is a side view of the attachment assembly of the present invention shown in a first position with the top part of a ladder inserted into the bottom portion of each of the two pivoting members. In this figure, the top part of a ladder 6 has been inserted into the bottom portion 3b of each of the two pivoting members 3 that make up the attachment assembly 1. As shown in this figure, the top-most rung 6a of the ladder 6 is situated within the arch-shaped cutout 31 above the safety pin 5. As noted above, the purpose of the safety pin 5 is to ensure that the ladder 6 does not slip out of the attachment assembly. In a preferred embodiment, the top edge 3f of the top portion 3a of the pivoting member 3 is at a fifty-degree (50°) angle relative to the outer edge of the bottom portion 3b of the pivoting member. This angle is preferably in the range of forty-five (45) to fifty (50) degrees.

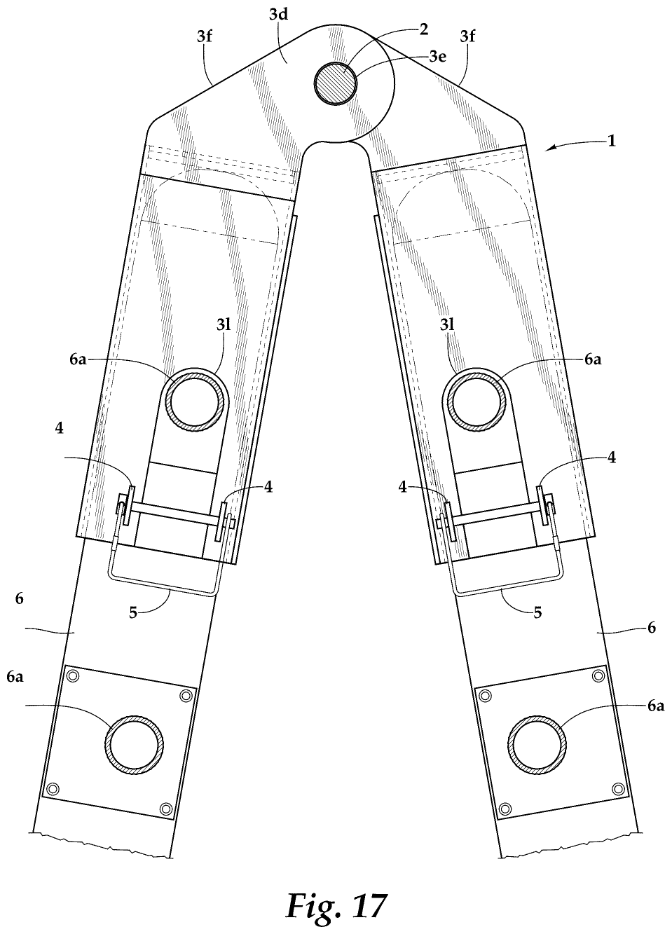

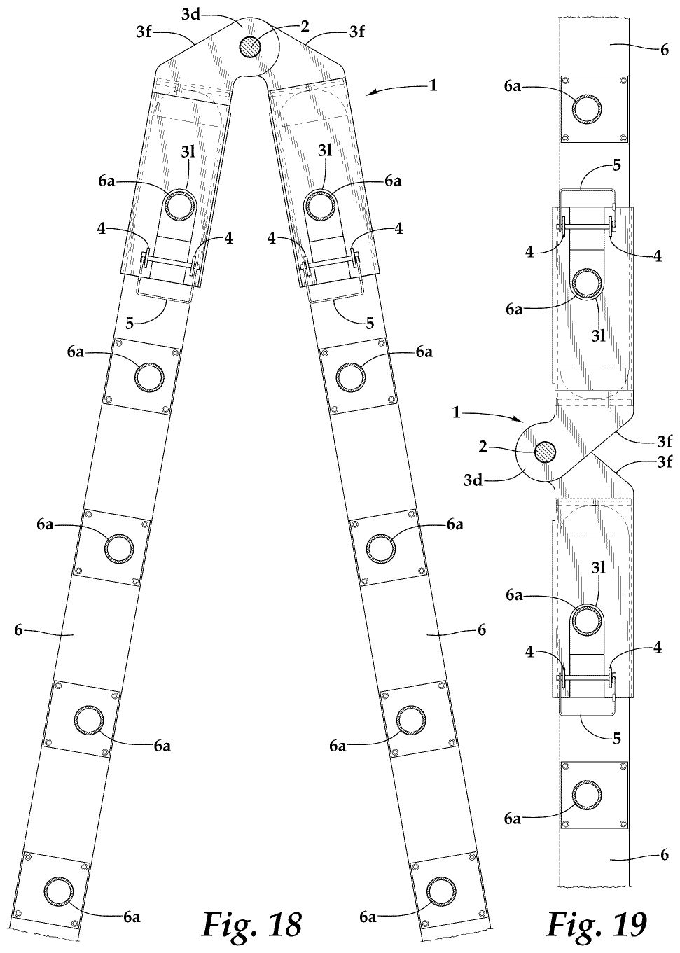

FIG. 17 is a side view of the attachment assembly of the present invention shown in a second position with the top part of a ladder inserted into the bottom portion of each of the two pivoting members. In this figure, the bottom ends of each of the pivoting members 3 have been rotated outward. In this manner, the two ladders 6 can be moved closer together or further apart, depending on the degree of rotation of the pivoting members (see also FIG. 18). Typically, the top-most rung 6a of the ladder is positioned below the top end of the arch-shaped cutout 31 so that the load is transferred to the ladder beams as opposed to the ladder rungs.

FIG. 19 is a side view of the attachment assembly of the present invention shown in a third position with the top part of a ladder inserted into the bottom portion of each of the two pivoting members. In this figure, the two pivoting members 3 have been rotated on the stabilizing bar 2 so that they are longitudinally aligned. The attachment assembly 1 might be placed into this position, for example, if it were laid on the ground in order to facilitate insertion of the ladders into the bottom portions 3b of the pivoting members 3.

FIG. 20 is a section view of both attachment assemblies on the stabilizing bar shown with the two pivoting members of each attachment assembly in a first orientation relative to each other. FIG. 21 is a section view of both attachment assemblies on the stabilizing bar shown with the two pivoting members of each attachment assembly in a second orientation relative to each other on the left-hand side of this figure and in a third orientation relative to each other on the right-hand side of this figure. In both of these figures, the outer pivoting member 3 are shown on the top, and the inner pivoting members 3 are shown on the bottom. In FIG. 20, the plates 3c of the inner pivoting member are situated inside of the plates 3c of the outer pivoting member. On the left-hand side of FIG. 21, the inner pivoting member has been moved to the left on the stabilizing bar 2 so that the plate 3c on the right side of the inner pivoting member abuts up against the plate 3c on the left of the outer pivoting member. On the right-hand side of FIG. 21, the inner pivoting member has been moved to the right, but not so far that the plate 3c on the left of the inner pivoting member comes into contact with the plate 3e on the right side of the outer pivoting member. By sliding the top portions 3a of the pivoting members 3 on the stabilizing bar, various configurations can be achieved to accommodate varying widths of ladders. In the configuration shown in FIG. 20, the two ladders are of the same width. In the configuration shown in FIG. 21, the ladder on the top of this figure is narrower than the ladder on the bottom of this figure.

FIG. 22 is a rear view of the present invention shown with the two attachment assemblies in different configurations. As used herein, the term “front view” as used in relation to FIGS. 5 and 12 means that part of the pivoting member 3 that faces the inside or center of the attachment assembly 1 when it is installed on the stabilizing bar 2. As used herein, the term “rear view” as used in relation to FIG. 22 means that part of the pivoting member 3 that faces outward or away from the stabilizing bar. In FIG. 22, the attachment assembly 1 on the left-hand side of the figure is in the configuration shown in FIG. 1. The attachment assembly 1 on the right-hand side of the figure is in a configuration similar (but not identical) to that shown on the right-hand side of FIG. 21. As shown in this figure, the invention preferably comprises a lynch pin 7 on either end of the stabilizing bar 2.

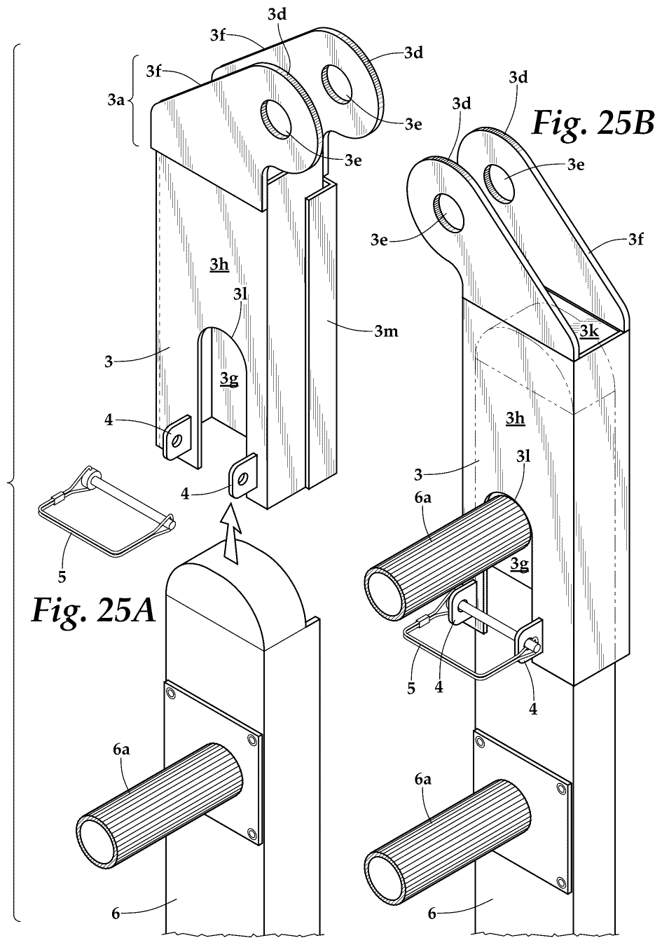

FIG. 23 is a perspective view of the inner pivoting member shown with the elongated bracket in an exploded position, and FIG. 24 is a perspective view of the inner pivoting member shown with the elongated bracket in an installed position. These two figures illustrate more clearly the elongated bracket 3m that is positioned on one side of the first side wall 3g. Although only the inner pivoting member is shown here, the outer pivoting member includes a similar elongated bracket. As shown here, the first side wall 3g incorporates a rectangular-shaped, vertically oriented cutout so that a part of the ladder (not shown) can extend into the channel formed by the elongated bracket 3m when inserted into the bottom portion 3b of the pivoting member 3. Note that the bottom of the elongated bracket 3m is open.

FIG. 25A is a perspective view of the outer pivoting member shown in relation to the top part of a ladder with the safety pin remove, and FIG. 25B is a perspective view of the inner pivoting member shown with the top part of a ladder inserted into the bottom portion of the pivoting member. These two figures show the positioning of the ladder rungs 6a before and after the top of the ladder 6 is inserted into the bottom portion 3b of the pivoting member 3. FIG. 25B also shows the safety pin 5, which is designed to prevent the ladder 6 from slipping downward and out of the pivoting member 3.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A ladder attachment apparatus comprising:
(a) a first attachment assembly;
(b) a second attachment assembly; and
(c) a stabilizing bar;
wherein each of the first and second attachment assemblies comprises a first pivoting member and a second pivoting member;
wherein each pivoting member is comprised of a top portion and a bottom portion;
wherein the top portion is comprised of a first plate and a second plate;
wherein the first plate and the second plate are arranged so that they are parallel to each other;
wherein each of the first plate and the second plate comprises an aperture that is configured to receive the stabilizing bar;
wherein the bottom portion of each pivoting member is in the form of a rectangular box with an open bottom end; and
wherein the bottom portion of each pivoting member comprises a first side wall with a cutout that is configured to receive a rung of a ladder when the rung is perpendicular to the side wall.

2. The ladder attachment apparatus of claim 1, wherein each of the first plate and the second plate has a rounded extension that is angled inwardly toward the stabilizing bar and a top edge that angles downwardly from the rounded extension to an outer edge of the top portion.

3. The ladder attachment apparatus of claim 1, wherein the bottom portion of each of the pivoting members comprises an elongated bracket that is configured to form a channel for receiving a part of a ladder; and
wherein the elongated bracket is situated on a second side wall of the bottom portion.

4. The ladder attachment apparatus of claim 1, wherein the stabilizing bar has a first end and a second end and comprises a first lynch pin on the first end of the stabilizing bar and a second lynch pin on the second end of the stabilizing bar.

5. The ladder attachment apparatus of claim 1, further comprising a pair of safety brackets on each pivoting member, with a first safety bracket being situated on a first side of a bottom end of the cutout on the first side wall and a second safety bracket being situated on a second side of the bottom end of the cutout on the first side wall; and
wherein both of the first and second safety brackets are configured to receive a safety pin.

6. The ladder attachment apparatus of claim 1, wherein the bottom member comprises a top plate; and
wherein the first plate and the second plate of the top portion of the first pivoting member are situated on top of the top plate of the bottom member.

7. The ladder attachment apparatus of claim 6, wherein the first plate and the second plate of the top portion of the second pivoting member are situated on either side of the top plate of the bottom member.
